(19) United States
(12) Patent Application Publication
(10) Pub. No.: US 2003/0219666 A1
(43) Pub. Date: Nov. 27, 2003

(54) Toner for developing static image, producing method therefor and image forming method using it

(76) Inventors: Tomoe Kitani, Tokyo (JP); Hiroshi Yamazaki, Tokyo (JP); Ken Ohmura, Tokyo (JP)

Correspondence Address: Squire, Sanders & Dempsey L.L.P., Suite 300, One Maritime Plaza, San Francisco, CA, 94111, US

(21) Appl. No.: 10/441,599

(22) Filed: May 19, 2003

(30) Foreign Application Priority Data
May 22, 2002 (JP) JP2002--147560

(51) Int. Cl. G03G 9/08

(52) U.S. Cl. 430/108.1; 430/137.1; 430/137.14; 430/124

(57) ABSTRACT

A toner for developing electrostatic latent image is disclosed. The total amount of a volatile substance contained in the toner is not more than 350 ppm by weight based on the total weight of the toner and an amount of a polymerizable monomer is not more than 50 ppm by weight based on the total weight of the toner, and the amount of the volatile substance and the polymerizable monomer are measured by a head space method.

### FIELD OF THE INVENTION

The invention relates to a toner for developing a static image to be used in an image forming apparatus such as a copying machine and a printer, a method for producing the toner for developing the static image and an image forming method using the toner.

### BACKGROUND OF THE INVENTION

Recently, an image formation by a digital system becomes the main stream in the field of electrophotography accompanied with progressing of the digital technology. The image forming method by the digital technology is based on visualizing a dot image of a small pixel such as 1,200 dpi. Consequently, a technology for reproducing such the small dot image with high fidelity has been required. In the above, dpi is the number of dot per inch or 2.54 cm.

The miniaturizing of the diameter of the toner for developing the static image, hereinafter also referred to as the toner, is progressed from the viewpoint of the high image quality. A toner produced by a crashing method has been mainly used up to the present. By the crashing method, a binder resin is mixed with a colorant and kneaded and crashed, and thus obtained powder is classified to produce the toner. However, there is a limitation on the miniaturization and uniformalization of the diameter of the toner particle produced such the method. Accordingly, attainment of sufficient high quality of the image is difficult in the electro photographic image forming by such the crashed toner.

Recently, a polymerized toner obtained by a suspension polymerization method or an emulsion polymerization method is noticed as a means for attaining the miniaturization of the particle diameter and uniformalization of the particle size distribution and the shape of the particle of the toner.

The method for producing the polymerized toner includes a method in which resin particles and colorant particles according to necessity are associated or salted out/fusion-adhered to form a toner comprising irregular shaped particles, and a method in which a colorant is mixed and dispersed with a radical polymerizable monomer and the dispersion is dispersed in a liquid so as to form droplets each having the designated diameter of the toner and thus obtained droplets in the suspension are polymerized. Among them, the former is preferable as the method to produce the toner comprising irregular shaped particles. In this method, the polymerization is carried out in the solution using a water-soluble polymerization initiator. A chain-transfer agent is used for controlling the molecular weight distribution, and a mercaptan compound is used as a suitable chain-transfer agent.

However, the volatile substance such as the polymerizable monomer and the chain-transfer agent to be used for the polymerization is difficultly removed completely from the toner on the occasion of the production and tends to be enclosed in the toner particle and remained.

The toner particle containing a large amount of the volatile substance or the polymerizable monomer tends to be coagulated. The developer using the coagulated toner tends to cause problems such as that the image quality is degraded and high quality image cannot be obtained, bad odor is occurred on the occasion of the fixing by heat by volatilization of the volatile substance or the polymerizable monomer remained in the toner, and the tacking of the printed surface of the image receiving material such as paper is occurred.

The problems caused by the presence of the polymerizable monomer or the volatile substance in the toner in not specifically noticed as to the crashed toner produced by melting, kneading and crashing of the resin and the colorant. As the reason of that, it is considered that the majority of the resin to be used for the crashed toner is previously dried, and the non-reacted polymerizable monomer or the volatile material is removed by heat in the melting and kneading process in the course of production of the toner even if such the substance is contained in the resin.

Besides, it is assumed that the foregoing problems are occurred in the case of the polymerized toner since the non-reacted polymerizable monomer or the volatile substance cannot be completely removed because the melting and kneading process are not contained in the production processes of the polymerized toner.

### SUMMARY OF THE INVENTION

The object of the invention is to provide a toner which is excellent in the storage stability and does not cause the bad odor at the fixing by heat, and the out put image receiving paper carrying an image formed by the toner is not tacked, a producing method of the toner, and an image forming process using such the toner.

The invention and preferable embodiments thereof are described below.

The toner of the invention contains a toner particle containing a binder resin and a colorant. The total amount of a volatile substance contained in the toner is not more than 350 ppm by weight based on the total weight of the toner and the amount of a polymerizable monomer is not more than 50 ppm by weight based on the total weight of the toner, and the amount of the volatile substance and the polymerizable monomer are measured by a head space method.

The production method of the toner mentioned above preferably comprises the following processes a process of forming a dispersion of toner particles from dispersion particles by coagulating and fusing.

Another production method of the toner mentioned above preferably comprises the following processes:

separating toner particles comprising colorant and a binder resin which are dispersed in water based medium, and

drying the toner particles.

The production method preferably comprises,

forming a colored resin particle by coagulation and fusing resin particles and colorant particles.

The production method of the toner preferably comprises the following processes:

a polymerization process for preparing a resin particle from the monomer;

a coagulation/fusion-adhering process for obtaining toner particle dispersion from the resin particles and the colorant particles;

a filtering and washing process for taking out the toner particles from the toner particle dispersion by filtering and for removing an impurity from the toner particles by washing; and

a drying process for drying the washed toner particles.

In the polymerization process, it is preferable to use an alkylmercaptan chain-transfer agent having from 5 to 10 carbon atoms.

In the polymerization process, it is preferable that a polymerization initiator is separately added into plural times.

In the drying process, the drying is preferably carried out under reduced pressure.

It is preferable that the alkylmercaptan having from 5 to 10 carbon atoms is used as the chain-transfer agent, and the polymerization initiator is separately added into plural times in the polymerization process, and the drying is carried out under the reduced pressure in the drying process.

The toner is preferably applied in an image forming method comprising a process for forming a static latent image; a process for forming a toner image by developing the static latent image using a developer containing the toner for developing the static latent image to form a toner image; a process for transferring the toner image to a image receiving material; a process for fixing by heat the toner image on the image receiving material; and a process for cooling the toner image fixed by heating.

The toner is preferably applied for an image forming apparatus comprising a means for forming a static latent image on a static image carrying member; a means for forming the toner image by developing the static image using a developer containing the toner for developing the static image; a means for transferring the toner image to an image receiving material; a means for fixing by heat the toner image on the image receiving material; and a means for cooling the toner image fixed by heating.

### BRIEF DESCRIPTION OF THE DRAWING

FIG. 1 is a cross-sectional view of an electrophotographic image forming apparatus as one example of the image forming apparatus of the present invention.

### DETAILED DESCRIPTION OF THE INVENTION

The toner according to the invention comprises the toner particle containing the binder resin, the colorant and an external additive such as a slipping agent according to necessity. The toner particle contains an internal additive such as a mold-releasing agent and a charge-controlling agent according to necessity. The toner sometimes contains the raw materials, a sub-product of theses components and a substance used for production of the toner.

It has been found by the inventors that it is important to control the amount of the volatile substance and the polymerizable monomer remained in the toner. As a result of the investigation on the substance adhered onto the developer conveying member, the developer layer thickness controlling member and the carrier of the two-component developer, it is understood that the toner containing a large amount of the volatile substance and the polymerizable monomer is adhered to these members and the carrier. The volatile substance and the polymerizable monomer remaining in the toner cause the occurrence of coagulation of the toner and the bad odor on the occasion of the fixing by heat. Other than the above, the volatile substance and the polymerizable monomer remaining in the toner dissolve the low molecular weight resin in the toner and accelerate the degradation of image quality, and cause at times tacking of the sheets of out put image receiving paper with each other and the paper difficultly trued up when the image is printed on both sides of the paper by a high speed printer. For inhibiting the occurrence of such the problems, it may be applied to increase the molecular weight of the resin of the toner. However, a problem of lowering of the fixing suitability is occurred since the softening point of the toner is raised by such the measure.

It is found as a result of the investigation on the remaining amount of the volatile substance and the polymerizable monomer in the toner that the object of the invention can be attained when the total amount of the volatile substance in the toner is not more than 350 ppm, preferably from 100 to 300 ppm by weight based on the total weight of the toner by weight based on the total weight of the toner, the polymerizable monomer in the volatile substance is not more than 50 ppm, preferably from 1 to 20 ppm, more preferably from 2 to 10 ppm.

Examples of the volatile substance are as follows: the polymerizable monomer remained after polymerization such as styrene, o-methylstyrene, acrylic acid, methacrylic acid, ethyl acrylate and butyl acrylate; the crosslinkable monomer such as divinylbenzene and polyethylene glycol dimethacrylate; the chain-transfer agent such as n-octylmercaptan and n-decyl mercaptan; the sub-product formed in the course of production of the toner such as butanol, decanol, dodecanol, an acryl ester and benzaldehyde; and the organic solvent used for the production of the toner such as benzene, xylene, ethylbenzene, ethyl acetate and butyl acetate.

The remaining amount of the volatile substance and the polymerizable monomer can be controlled by various methods such as simply heating, prolonging the time of the polymerization and increasing the amount of the polymerization initiator. However, the control by such the methods is not satisfactory and the control can be sufficiently carried out by the addition of the initiator at plural times, the use of the alkylmercaptan having from 5 to 10 carbon atoms as the chain-transfer agent and drying under the reduced pressure.

The resin particle is obtained by the polymerization reaction in the aqueous medium using the water-soluble polymerization initiator. When the radical supplied by the polymerization initiator is reduced in the course of the polymerization reaction, the polymerization propagation ratio is lowered and the slight amount of the polymerizable monomer is finally remained. The amount of the remained polymerizable monomer can be reduced by separately adding the polymerization initiator into plural times so as to reduce the remaining amount of the volatile substance and the polymerizable monomer. In concrete, it is preferable that the polymerization initiator is additionally added at the time when the polymerization propagation ratio becomes 90% or more. The polymerization propagation ratio can be known by the following procedure: a designated amount of the reacting liquid is sampled in the course of the polymerization and the weight of the sample is precisely measured, and then the sample is dried and the weight of the dried sample is measured and compared with the weight of the raw sample.

The amount of the polymerization initiator to be additionally added is preferably from 10 to 100%, more preferably from 20 to 80%, by weight of the initially added amount of the polymerization initiator. The additionally adding amount is controlled so that the remaining amount is not excessive and suitable charging property is obtained. The amount of the volatile substance can be further preferably controlled by the use of the alkylmercaptan having from 5 to 10 carbon atoms as the chain-transfer agent for the polymerization process.

It is preferable to perform the drying under reduced pressure.

In the head space method to be used for measuring the amount of the volatile substance and the polymerizable monomer contained in the toner, the toner is enclosed in a sealed container and heated by a temperature about the fixing temperature of the copier and the gas in the container is rapidly injected into the gas chromatography apparatus at the time when the container is filed by the volatile component to measure the amount of the volatile component and to analyze by mass spectroscopic analysis (MS).

As the method for measuring the amount of the impurity originated in the binder resin and the additive added in a small amount, a method is known in which the binder resin or the toner is dissolved by a solvent and the solution is injected into the gas chromatograph apparatus. However, this method is not suitable for measuring the whole amount of the volatile component since the peak of the impurity and that of the slightly added additive are sometimes hided by the peak of the solvent. The peaks of the volatile components can be wholly observed bi the gas chromatography in the head space method used in the invention, and the remaining components can be quantitatively measured with higher precision by the analytical method utilizing the electromagnetic interaction.

The head space gas chromatographic measurement method will now be described.

<Head Space Gas Chromatographic Measurement Method>

1. Sampling Samples

Charged in a 20-ml vial for head space is 0.8 g of a sample. The weight of the sample is measured to the second decimal of 0.01 (since it is necessary to calculate the area per unit weight). The vial is sealed with a septum.

2. Heating Samples

Samples are placed in a thermostat at 170° C. so that each vial remains erect and are heated for 30 minutes.

3. Setting of Gas Chromatograph Separation Conditions

A column having an inner diameter of 3 mm and a length of 3 m, filled with carriers which are coated with silicone oil SE-30 so as to achieve a weight ratio of 15 is employed as a separation column. The resulting separation column is installed in the gas chromatography and He, as a carrier, is allowed to flow at a rate of 50 ml/minute. The separation column is heated to 40° C. and subsequently measurements are carried out while raising the temperature to 200° C. at a rate of 15 ° C./minute. After reaching 200° C., the temperature is maintained for 5 minutes.

4. Introduction of Sample

The vial is removed from the thermostat, and immediately 1 ml of gas, generated from the sample, is collected employing a gas tight syringe. Subsequently, the collected gas is injected into the above mentioned column.

5. Calculation

An amount of substances detected between the time to detect the peaks of n-hexane and the time to detect n-hexadecane is regarded as a whole amount of the volatile substances.

In advance, a calibration curve is prepared employing an aromatic hydrocarbon compound utilized as an inner standard material. The concentration of each component is determined based on the corresponding calibration curve.

6. Apparatus and Material

(1) Head Space Conditions

Head Space Apparatus

HP7694 “Head Space Sampler” manufactured by

Hewlett-Packard Corp.

Temperature Conditions

Transfer line: 200° C.

Loop temperature: 200° C.

Sample Amount: 0.8 g/20 ml vial

(2) GC/MS Conditions

GC: HP5890 manufactured by Hewlett-Packard Corp.

MS: HP5971 manufactured by Hewlett-Packard Corp.

Column: HP-624, 30 m×0.25 mm

Oven temperature: 40° C. (maintained for 3 minutes)—

rising 10° C./minute—to 200° C.

Measurement mode: SIM

In actual measurement, standard samples n-hexane and n-hexadecan are measured preliminarily according to the oven temperature program mentioned above, and the time for detecting each peak of substance is confirmed. After that a sample is measured in accordance with the temperature program mentioned above, and whole area of substances detected between the time to detect the peaks of n-hexane and the time to detect n-hexadecane is converted by a toluene capillary curve. The substances of detected peak having 0.1 ppm or more as toluene converted amount is measured. Whole amount of the volatile substance and an amount of polymerizable monomer among them are analyzed.

<Toner Production Method>

The production method of the toner is described below.

The toner of the invention contains the toner particle containing the binder resin and the colorant. The toner sometimes contains an external additive such as a slipping agent additionally to the toner particle. The toner particle sometimes contains an internal additive such as a charge controlling agent.

Firstly, the production method of the toner particle is described.

The toner of the invention may be prepared by a method of suspension polymerization, a method of coagulating/fusing particles obtained by an emulsion polymerization method, a method of dissolving suspension method in which a resin is dissolved and dispersed in a medium, and so on. A preferable method, by which lee amount of volatile substance remained in toner particles, is the method of coagulating/fusing particles obtained by an emulsion polymerization method. Examples of the preparation methods are described.

<Suspension Polymerization>

One example of the method for producing the toner of the present invention is as follows. Various types of components such as colorants, and if desired, release agents, and polymerization initiators are added into polymerizable monomers, and subsequently, the various types of components are dissolved in or dispersed into the polymerizable monomers, employing a homogenizer, a sand mill, a sand grinder, or an ultrasonic homogenizer. The resulting monomers, which comprise dissolved or dispersed components, are dispersed into a water-based medium, employing a homomixer or a homogenizer so as to form oil droplets, having the specified size as toner particles.

Thereafter, the resulting dispersion is placed in a reaction apparatus (being a stirring apparatus), which is fitted with stirring mechanisms, which refer to the stirring blade described below, and undergoes reaction while being heated. As a result, fine resin particles are prepared. Subsequently, the coagulants such as salts are added and the resin particles are aggregated and fused. Thereafter, the resulting toner particles are separated, washed; the impurities in the toner particles are removed, and dried, whereby the toner of the present invention is prepared. The term “water-based medium” is used to refer to a medium which is comprised of at least 50 percent of water by weight.

<Emulsion Polymerization>

A resin particles are prepared employing an emulsion polymerization method wherein polymerizable monomer or mixture of the monomer and additives such as a colorant and a releasing agent is polymerized by adding them to a water based medium containing emulsifier and polymerization initiator. The obtained dispersed emulsion polymer particles are aggregated and fused, and subsequently, heated to a temperature higher or equal to the glass transition point so as to be fused. Thereafter, the resulting dispersion is salted out by adding coagulants in an amount of at least the critical aggregation concentration. The resulting polymer is heated to higher or equal to the glass transition temperature, and preferably, the particle size is allowed to gradually increase. When the particle size reaches the specified value, the aggregation terminating agents are added so as to terminate an increase in particle size. Further, during heating and stirring, the particle surface is smoothed and the particle shape is controlled. Subsequently, the resulting particles are separated from the dispersion and heat dried, whereby it is possible to form the toner of the present invention.

<Dissolving Suspension Method>

In the solution-dispersing method for dissolving and dispersing the resin in a liquid, the resin obtained by the addition polymerization reaction or the condensation polymerization reaction is dissolved by a solvent or liquefied by heat treatment and dispersed by a dispersing means such as a ball mill, a sand mill and a homogenizer, and the dissolved or liquefied resin is emulsified in an aqueous medium using a surfactant or an emulsifying agent. An emulsifying machine such as T. K. Homomixer, manufactured by Tokushu Kika Kogyo Co., Ltd., Ebaramilder, manufactured by Ebara Corporation and CLEARMIX, manufactured by M.Technique Co., Ltd., are used for the emulsification. On the occasion of the emulsification, the designated diameter and the diameter distribution of the emulsified droplets can be obtained by controlling the concentration of the emulsifying agent, the concentration of the solid component in the organic solvent, the amount ratio of the aqueous medium to the oil phase in which the solid component is dispersed, or the rotating speed and the period for emulsifying. The dispersion is preferably performed so that the diameter of the emulsified droplet is become to ½ to 1/100 of the diameter of the objective toner particle. The weight ratio of the solid component to the organic solvent and the weight ratio of the aqueous medium to the oil phase in which the solid component is dispersed are each optionally selected from the range of from 1:10 to 1:1 and from 10:1 to 1:1, respectively.

There is no limitation on the organic solvent for dissolving and dispersing the solidified toner component as long as the solvent is one insoluble, sparingly soluble or partially soluble in water and capable of dissolving the resin composing the solid composition or the resin used on the occasion of the kneading. Examples of the solvent include toluene, xylene, benzene, carbon tetrachloride, methyl acetate, ethyl acetate, methyl ethyl ketone and methyl isobutyl ketone; they may be used singly or in combination. An aromatic solvent such as toluene and xylene and an organic ester are particularly preferred.

For removing the organic solvent from thus obtained emulsified dispersion, a method can be applied by which the whole system is gradually heated to completely remove the organic solvent by evaporation. The pressure reduction is preferably applied on this occasion since the heating temperature can be lowered. The dissolving out of the toner constituting component such as wax into the organic solvent and the irregular re-coagulation, association and unifying of the emulsified droplets caused by the heating can be inhibited. The organic solvent removing process may be applied either before or after the coagulation/fusion-adhering process or the coagulation process. The organic solvent removing before the coagulation/fusion-adhering process or the coagulation process is preferred since the resin dispersion is stabilized, the coagulation is easily controlled and the particle diameter distribution is made sharp.

As another treating method of the emulsified dispersion using the organic solvent, it is possible that the emulsified dispersion is sprayed into a drying atmosphere for completely removing the water-insoluble organic solvent in the droplet to form the toner fine particle; and the aqueous dispersing medium can also removed at the same time. For the atmosphere in which the emulsified dispersion to be sprayed, heated gas, particularly the gas heated at a temperature higher than the boiling point of the solvent having the highest boiling point, such as air, nitrogen, carbon dioxide and combustion gas are usually used. The sufficient quality of the product can be obtained by a short time treatment by a device such as a spray dryer, a belt dryer and a rotary kiln.

The following methods can be applied for coagulating the resin particles by the coagulation/fusion-adhering. When the resin particles with electric charge are dispersed in the aqueous medium, the following methods are preferably applied: a method in which the particles are coagulated with together by adding an electrolyte such as a salting out agent or coagulating agent to compressing the electrical double layer; a method in which the particles are coagulated with each other by a high molecular weight water-soluble polymer particles absorbed to each the particles; a method in which the particles are coagulated with each other by adding a substance having the charge reverse to the charge of the surfactant or the dispersing agent used in the dispersion for neutralizing the charge of the particles; a method in which the counter ion of the surfactant or the dispersing agent absorbed to the particles is changed; and a method in which the particles are coagulated by adding another substance to the dispersion for varying the solubility of the surfactant or the dispersing agent to the aqueous medium to lower the stability of the dispersion.

On this occasion, an emulsion of mold releasing agent, referred to as wax, or fine particles of resin having a polarity may be coagulated together with the particles to give the mold releasing ability on the occasion of the fixing or enhanced triboelectricity property to the toner to be produced. The blocking of the toner particles during the storage at high temperature can be also prevented by arranging a particle of resin having a high glass transition point at the outer side of each of the toner particles. The toner is produced by separating the solvent or the water from the resin dispersion or the dispersion of the coagulated resin particles formed by the coagulating/fusion-adhering the resin dispersion, and drying.

Most preferable emulsion polymerization method is detailed. The method comprises the following processes:

a polymerization process for preparing the resin particles from the monomer;

a coagulation/fuse-adhering process for obtaining toner particle dispersion from the resin particles and the colorant particles;

a filtration and washing process for separating the toner particles from the dispersion by filtration and for removing the impurity from the toner particles: and

a drying process for drying the washed toner particle.

In this case, the toner particle is prepared by adding the colorant particles to the dispersion of the resin particles and coagulating and fusion-adhering the rein particles with the colorant particles. Both of the resin particle and the colorant particle are preferably have each a particle diameter of from 50 to 200 nm. The resin particles and the colorant particles preferably have each uniform particle diameter. The resin particle is preferably prepared without the presence of the colorant. The resin particle is preferably a complex resin particle. Such the resin particles are salted out, coagulated and fusion-adhered with the colorant to form the toner particles having a number average particle diameter of from 3 to 10 μm.

The toner particle constituting the toner according to the invention is a multi-layer structured resin particle which comprises a resin core particle and one or more resin layer covering the core resin particle, the resins of plural covering layers are different from each other in the molecular weight and/or the composition thereof.

The core particle is the resin particle constituting the central portion or the core of the complex resin particle.

The outer layer or the shell is the outermost layer among the one or more covering layer constituting the complex resin layer.

The interlayer is the layer formed between the central portion (core) and the outer layer (shell).

In the invention, the molecular weight distribution of each of the central portion, the interlayer and the outer layer can be controlled by applying a poly-step polymerization method and a suitable fixing strength and an anti-offset ability can be obtained. In the poly-step polymerization method for obtaining the complex resin particle, a resin particle dispersion is prepared by the polymerization of a monomer, the first step, and then another monomer is added and polymerized, the second step, to form a particle constituted by the core particle obtained by the first step of the polymerization and a covering layer composed of the resin formed by the second step of polymerization. Furthermore, another monomer is added and polymerized to form a next layer. The polymerization steps are each controlled so that the resins formed on each of the polymerization steps are different from each other in the molecular weight, dispersing state and/or composition.

When the monomer is added to the core particle and polymerized, the polymerization is a two-step polymerization, and when the other monomer is further added and polymerized, the polymerization is a three-step polymerization. Thus three or more-step polymerization can be carried out.

The molecular weight distribution of the complex resin particle is not Monodispersion. In the complex resin particle, the central portion (core), interlayer and outer layer (shell) are each constituted by the resins different from each other in the molecular weight thereof. The complex resin particle has the largest molecular weight at the central portion, and a slop of molecular weight through the central portion to the outermost layer.

Plural kinds of resin different form each other in the composition and/or the molecular weight are contained in the complex resin particle. However, variation of the composition, molecular weight and the resin composition at the particle surface between the individual particles is very small. Consequently, the fluctuation of the composition, molecular weight and the surface property between the individual toner particles each prepared by coagulation and fusion-adhering of the complex resin particles and the colorant particles is very small.

The toner production method according to the invention is concretely described below referring an example of poly-step polymerization method.

The production method comprises (I) the following processes:

a poly-step polymerization process to obtain the complex resin particle;

a coagulating and fusion-adhering process (II) for coagulating and fusion-adhering the complex resin particles and the colorant particles to obtain the toner particle;

a filtering and washing process for separating the toner particles from the toner particle dispersion by filtration and removing the surfactant from the toner particles;

a drying process for drying the washed toner particles; and

a process for adding an external additive to the dried toner particles.

Each of the processes is described below.

<Poly-step Polymerization Process (I)>

A poly-step polymerization process having two or more steps is preferably applied from the viewpoint of the stability of the production and the anti-crashing strength of the toner.

The two-step polymerization method and the three-step polymerization method are described below as typical examples of the poly-step polymerization method.

<Two-step Polymerization Method>

The two-step polymerization method is a method for producing the complex resin particle comprising the central portion (core) of a high molecular weight resin and the outer layer of a low molecular weight resin. Namely, the complex resin particle obtained by the two-step polymerization method is constituted by the core and one covering layer.

In concrete, a monomer solution was dispersed as an oil droplet in an aqueous medium or an aqueous solution of a surfactant. This system is subjected to a polymerization treatment as the first step of the polymerization to prepare a dispersion of a resin particle H which is used as the core particle. In the first step of the polymerization, the polymer having a molecular weight higher than that of the resin formed in the second step of the polymerization. The core particle containing a mole releasing agent can be obtained by dissolving the mold releasing agent into the monomer H.

Then a polymerization initiator and a monomer L are added to the dispersion of the resin particle H. This system is subjected to a polymerization treatment in the presence of the resin particle H as the second polymerization step to form a covering layer L composed of the polymer of the monomer L on the surface of the resin particle H. The molecular weight of the resin of the covering layer L is made so as to be lower than that of the core particle.

<Three-step Polymerization Method>

The three-step polymerization method is a method for producing the complex resin particle comprising the central portion (core) of a high molecular weight resin, the interlayer of comprising a resin of an intermediate molecular weight and the outer layer comprising a resin of low molecular weight. Namely, the complex resin particle prepared by the three-step polymerization method comprises the core and the two covering layers. When the complex resin particle containing the mold-releasing agent is prepared, the mold releasing layer is preferably contained in the interlayer.

Such the method is concretely described below. A dispersion of the resin particle H prepared by the polymerization treatment as the first step polymerization is added to an aqueous medium or an aqueous solution of a surfactant containing a monomer M. This system is subjected to a polymerization treatment as the second step polymerization to prepare a dispersion of complex resin particle which comprises the resin particle H (core) and a layer M (interlayer) comprising the resin or the polymer of the monomer M and covering the surface of the resin particle H. When a mold releasing agent is used, the mold releasing agent is dissolved in the monomer M.

Then the polymerization initiator and a monomer L for forming a low molecular weight resin are added to the above obtained dispersion of the complex resin particle. A covering layer L comprises a low molecular weight resin or a polymer of the monomer L was formed on the surface of the complex resin particle by a polymerization treatment, the third step of polymerization in the presence of the complex resin particle.

<Three-Step Polymerization Method>

The three-step polymerization method is a method to prepare composite resin particles which are comprised of a central portion (being a nucleus) comprised of high molecular weight resins, an interlayer and an outer layer (being a shell) comprised of low molecular weight resins. The toner particle of the present invention is formed as the composite resin particle.

This method will now be specifically described. Initially, a dispersion comprised of resin particles, which have been prepared by polymerization (the first step polymerization) according to a conventional method, is added to a water-based medium (for example, an aqueous surface active agent solution). After dispersing a monomer solution into the water-based medium so as to form oil droplets, the resulting system undergoes polymerization (the second step polymerization), whereby a covering layer (an interlayer) comprised of resins is formed on the surface of resin particles (nucleus particles). Thus a composite resin particle (comprised of high molecular weight resins and intermediate molecular weight resins) dispersion is prepared.

Subsequently, polymerization initiators and monomers to prepare a low molecular weight resin are added to the resulting composite resin particle dispersion, and the monomers undergo polymerization (the third step polymerization) in the presence of the composite resin particles, whereby a covering layer comprised of a low molecular weight resin (a polymer of the monomers) is formed.

A binder resin employed in the toner particles will now be described.

<Polymerizable Monomers>

Employed as polymerizable monomers to prepare a resin (binder), employed in the present invention, are hydrophobic monomers as an essential composition element and if necessary, crosslinkable monomers. Further, it is preferable that at least one kind of monomers having an acidic polar group or a basic polar group in the structure, as shown below, is incorporated.

(1) Hydrophobic Monomers

Hydrophobic monomers, which constitute a monomer component, are not particularly limited, and conventional monomers known in the art may be employed. Further, the monomers may be employed individually or in combination of at least two types so as to realize desired characteristics.

Specifically employed may be monovinyl aromatic based monomers, (meth)acrylic acid ester based monomers, vinyl ester based monomers, vinyl ether based monomers, monoolefin based monomers, diolefin based monomers, or halogenated olefin based monomers.

Listed as vinyl aromatic based monomers may be, for example, styrene based monomers such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrne, and 3,4-dichlorostyrne, and derivatives thereof.

Listed as (meth)acrylic acid ester based monomers my be acrylic acid, methacrylic acid, methyl acrylate, ethyl acrylate, butyl acrylate, acrylic acid-2-ethylhexyl, cyclohexyl acrylate, phenyl acrylate, methyl methacrylate, ethyl methacrylate, butyl methacrylates, hexyl methacrylates, methacrylic acid-2-ethylhexyl, ethyl β-hydroxyacrylate, propyl γ-aminoacrylate, stearyl methacrylates, dimethyl aminoethyl methacrylates, and diethyl aminoethyl methacrylate.

Listed as vinyl ester based monomers may be vinyl acetate, vinyl propionate, and vinyl benzoate, while listed as vinyl ether monomers may be vinyl methyl ether, vinyl ethyl ether, vinyl isobutyl ether, and vinyl phenyl ether.

Further, listed as monoolefin based monomers may be ethylene, propylene, isobutylene, 1-butene, 1-pentene, and 4-methyl-1-pentene, while listed as diolefin based monomers ma be butadiene, isoprene, and chloroprene.

(2) Crosslinkable Monomers

In order to improve the characteristics of resin particles, crosslinkable monomers may be incorporated. Listed as crosslinkable monomers are, for example, monomers such as divinylbenzene, divinylnaphthalene, divinylether, diethylene glycol methacrylate, ethylene glycol methacrylate, polyethylene glycol dimethacrylate, and diallyl phthalate, all of which have at least two unsaturated bonds.

(3) Monomers having an Acidic Polar Group

Listed as monomers having an acidic polar group may be α, β-ethylenic unsaturated compounds having a carboxylic group (—COOH) and α, β-ethylenic unsaturated compounds having a sulfonic group (—SO₃H)

Listed as examples of α, β-ethylenic unsaturated compounds having a carboxylic group may be acrylic acid, methacrylic acid, fumaric acid, maleic acid, itaconic acid, cinnamic acid, monobutyl maleate, monooctyl maleate, and metal salts thereof, such as Na salts and Zn salts.

Listed as examples of α, β-ethylenic unsaturated compounds having a sulfonic group may be sulfonated styrene and Na salts thereof, and allylsulfosuccinic acid and octyl allylsulfosuccinate and Na salts thereof.

(4) Monomers having a Basic Polar Group

Demonstrated as monomers having a basic polar group may be (meth)acrylic acid esters of aliphatic alcohols, having an amine group or a quaternary ammonium group, which have from 1 to 12 carbon atoms, preferably from 2 to 8 carbon atoms, and more preferably 2 carbons atoms; (meth)acrylic acid amides or (meth)acrylic acid amides which are subjected to mono or di-substitution on optional carbon atom(s) with an alkyl group having from 1 to 18 carbon atoms; vinyl compounds substituted with a heterocyclic group having N as a ring member; and N,N-diallyl-alkylamines or quaternary ammonium salts thereof. Of these, preferred as monomers having a basic polar group are (meth)acrylic acid esters of aliphatic alcohols having an amine group or a quaternary ammonium group.

Listed as examples of (meth)acrylic acid esters of aliphatic alcohols having an amine group or a quaternary ammonium salt may be dimethyl aminoethyl acrylate, dimethyl aminoethyl methacrylate, diethyl aminoethyl acrylate, diethyl aminoethyl methacrylate, quaternary ammonium salts of the four compounds, 3-dimethylaminophenyl acrylate, and 2-hydroxy-3-methacryloxypropyltrimethl ammonium salt.

Listed as (meth)acrylic acid amides which are subjected to mono- or di-substitution on optional carbon atom(s) with an alkyl group may be acrylamide, N-butylacrylamide, N,N-dibutylacrylamide, piperidylacrylamide, methacrylamide, N-butylmethacrylamide, N,N-dimethylacrylamide, and N-octadecylacrylamide.

Listed as vinyl compounds substituted with a heterocyclic group having N as a ring member may be vinylpyridine, vinylpyrrolidone, vinyl-N-methylpyridinium chloride, and vinyl-N-ethylpyridinium chloride.

Listed as examples of N,N-diallyl-alkylamines may be N,N-diallylmethylammonium chloride and N,N-diallylammonium chloride.

(Initiator)

In the present invention, radical polymerization initiators may suitably be employed, as long as they are water-soluble. Listed as those are, for example, persulfates (for example, potassium persulfate and ammonium persulfate, azo based compounds (for example, 4,4-azobis-4-cyanovaleric acid and salts thereof), and peroxide compounds. Further, if desired, the radical polymerization initiators may be combined with reducing agents so as to be used as a redox system initiator. The use of the redox system initiators results in advantages such as an increase in polymerization activity, a decrease in polymerization temperatures, and a decrease in polymerization time.

Polymerization temperatures are not particularly limited, as long as they are higher or equal to the minimum radical formation temperature of the polymerization initiator, and are, for example, in the range of 50 to 90° C. However, by employing polymerization initiators comprised of a hydrogen peroxide-reducing agent (such as ascorbic acid) combinations, which are capable of initiating polymerization at room temperature, it is possible to carry out polymerization at room temperature or higher.

(Chain Transfer Agent)

A chain transfer agent may be used for the purpose of adjusting the molecular weight. Preferable examples include an alkylmercaptan having 5 to 10 carbon atoms.

Listed as preferred compounds may be n-pentyl mercaptan, n-hexyl mercaptan, n-butyl mercaptan, n-octyl mercaptan, n-nonyl mercaptan, n-decyl mercaptan, and 2-ethylhexyl mercaptan.

Amount of the chain transfer agent to be employed is 0.01 to 5 weight %, more preferably 0.05 to 4 weight %, based on the radical polymerizable monomer composition.

Water based medium used in this invention is a mixture of water and an organic solvent. The water based medium is composed of 50 to 100 weight % of water and remaining amount of water soluble organic solvent. Examples of the solvents include methanol, ethanol, isopropanol, butanol, acetone, methylethylketone, and tetrahydrofuran, and among these preferable are those do not dissolve the obtained resin such as alcoholic solvents.

(Surface Active Agents)

In order to carry out mini-emulsion polymerization employing the polymerizable monomers, it is preferable that oil droplet dispersion is carried out in a water-based medium, employing surface active agents. Surface active agents usable for the dispersion are not particularly limited, however, it is possible to list ionic surface active agents as examples of suitable compounds.

Listed as ionic surface active agents are, for example, sulfonates (sodium dodecylbenzenesulfonate, sodium arylalkylpolyethersufonate, sodium 3,3-disulfonedophenylurea-4,4-diazo-bis-amino-8-naphthol-6-sulfonate, ortho-carboxybenzene-azo-dimethylaniline, and sodium 2,2,5,5-tetramethyl-triphenylmethane-4,4-diazo-bis-β-naphthol-6-sulfonate), sulfuric acid ester salts (sodium dodecylsulfonate, sodium tetradecylsulfonate, sodium pentadecylsulfonate, and sodium octylsulfonate), and aliphatic acid salts (sodium oleate, sodium laurate, sodium caprate, sodium caprylate, sodium caproate, potassium stearate, and calcium oleate).

Further, in the present invention, it is possible to employ nonionic surface active agents, which specifically include polyethylene oxide, polypropylene oxide, combinations of polypropylene oxide and polyethylene oxide, esters of polyethylene glycol with higher fatty acids, alkylphenol polyethylene oxide, esters of higher fatty acid with polyethylene glycol, esters of higher fatty acids with polypropylene oxides, and sorbitan esters.

In the present invention, these surface active agents are employed mainly as an emulsifier during emulsion polymerization. However, they may be employed in other processes or for other purposes.

(Colorants)

The toner of the present invention is preferably prepared by aggregating and fusing the composite resin particles and colorant particles.

Listed as pigments for magenta or red are, for example, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48 : 1, C.I. Pigment Red 53 : 1, C.I. Pigment Red 57 : 1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Listed as pigments for orange or yellow are, for example, C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, C.I. Pigment Yellow 138, C.I. Pigment Yellow 180, C.I. Pigment Yellow 185, C.I. Pigment Yellow 155, and C.I. Pigment Yellow 156.

Listed as pigments for green or cyan are, for example, C.I. Pigment Blue 15, C.I. Pigment Blue 15 : 2, C.I. Pigment Blue 15 : 3, C.I. Pigment Blue 16, C.I. Pigment Blue 60, and C.I. Pigment Green 7.

Further, employed as dyes may be, for example, C.I. Solvent Red 1, the same 49, the same 52, the same 58, the same 63, the same 111, and the same 122; C.I. Solvent Yellow 19, the same 44, the same 77, the same 79, the same 81, the same 82, the same 93, the same 98, the same 103, the same 104, the same 112, and the same 162; and C.I. Solvent Blue 25, the same 36, the same 60, the same 70, the same 93, and the same 95. In addition, mixtures thereof may also be employed.

These pigments as well as these dyes may be employed individually or in combination of a plurality of selected ones. Further, the added amount of pigments is typically from 2 to 20 percent by weight with respect to the polymer, and is preferably from 3 to 15 percent.

Colorants (colorant particles) which constitute the toner of the present invention may be subjected to surface modification. Employed as surface modifiers may be those which are conventionally known in the art. Specifically silane coupling agents, titanium coupling agents, and aluminum coupling agents may preferably be employed. Listed as silane coupling agents are, for example, alkoxysilanes such as methylmethoxysilane, phenylmethoxysilane, methylphenyldimethoxysilane, diphenyldimethoxysilane, siloxanes such as hexamethyldisiloxane, γ-chloropropyltrimethoxysilane, vinyltrichlorosilane, vinyltrimethoxysilane, vinyltriethoxysilane, γ-methacryloxypropyltrimethoxysilane, γ-glycidoxypropyltrimethoxysilane, γ-mercaptopropyltrimethoxysilane, γ-aminopropyltriethoxysilane, and γ-ureidopropyltriethoxysilane. Listed as titanium coupling agents are, for example, TTS, 9S, 38S, 41B, 46B, 55, 138S, and 238S which are manufactured by Ajinomoto-Fine-Techno Co., Inc., and are commercially available under the product name PLENACT, and commercially available products, A-1, B-1, TOT, TST, TAA, TAT, TLA, TOG, TBSTA, A-10, TBT, B-2, B-4, B-7, B-10, TBSTA-400, TTS, TOA-30, TSDMA, TTAB, and TTOP, manufactured by Nippon The Co., Ltd. Listed as an aluminum coupling agent is, for example, PLENACT AL-M, manufactured by Ajinomoto-Fine-Techno Co., Inc.

The added amount of these surface modifiers is preferably from 0.01 to 20.0 percent by weight with respect to the colorant, and is more preferably from 0.2 to 5.0 percent.

Further, listed as the surface modification method of colorant particles is a method in which surface modifiers are added to colorant particle dispersion and the resulting mixture is heated so as to initiate a reaction.

Surface modified colorant particles as above are collected by filtration. Subsequently, the collected particles are subjected to repeated washing and filtration employing the same solvent, and then dried to prepare the final product.

The colorant subjected to surface modification is dispersed in water base medium and employed in a process of coagulation and fusing.

Homogenizers employed in the dispersion of the colorant particles include, for example, CLEARMIX ultrasonic homogenizers, mechanical homogenizers, and Manton-Gaulin homogenizers, pressure type homogenizers and medium dispersion machines such as GETSMAN MILL and DIAMOND FINE MILL.

The toner of the invention can be obtained by forming a resin layer on the surface of the particles of a resin and a colorant by means of coagulation. The method is detailed below.

The particle for dispersion particle of this invention includes resin a particle, a colorant particle, a releasing agent particle, a resin particle containing a colorant, a resin particle containing a releasing agent, and a mixture of two or more of these particles.

Coagulation/fusion process of the invention is that the processes of coagulation of fine particles and fusion (distinction of surface between the fine particles) occur simultaneously, or the processes of coagulation and fusion are induced simultaneously. Particles (composite resin particles and colorant particles) are subjected to coagulation preferably in such a temperature condition as lower than the glass transition temperature (Tg) of the resin composing the composite resin particles so that the processes of coagulation of fine particles and fusion (distinction of surface between the fine particles) occur simultaneously.

The coagulation is a process to form a desirable lump by gathering particles. The method includes coagulation by employing a salt, coagulation by changing temperature, coagulation by changing pH of a solvent, and so on. The coagulation by employing a salt is preferably among these methods.

Particles of additives incorporated within toner particles such as a charge control agent (particles having average diameter from 10 to 1,000 nm) may be added as well as the composite resin particles and the colorant particles in the coagulation/fusion process. Surface of the colorant particles may be modified by a surface modifier.

The colorant particles are subjected to coagulation/fusing treatment as they are dispersed in the water base medium. Example of the water base medium is water containing surface active agent not more than critical micelle concentration (CMC).

In the process of coagulation and fusion composite resin particles and colorant particles are subjected to coagulation and fusion wherein coagulation and fusion are caused simultaneously.

It is preferable that composite resin particles and colorant particles are coagulated at a temperature higher than a Tg of the resin composing composite resin particles.

It is preferable to add a coagulant in an amount of more than critical micelle concentration to a dispersion comprising composite resin particles and colorant particles, and heated the dispersion at temperature higher than Tg of composite resin particles.

Though the coagulation terminator is not necessary, it is preferable that the terminator is added when a particle diameter reaches target particle diameter by the coagulation.

(Coagulant)

Coagulants are preferably selected from metallic salts.

Listed as metallic salts, are salts of monovalent alkali metals such as, for example, sodium, potassium, lithium, etc.; salts of divalent alkali earth metals such as, for example, calcium, magnesium, etc.; salts of divalent metals such as manganese, copper, etc.; and salts of trivalent metals such as iron, aluminum, etc.

Some specific examples of these salts are described below. Listed as specific examples of monovalent metal salts, are sodium chloride, potassium chloride, lithium chloride; while listed as divalent metal salts are calcium chloride, zinc chloride, copper sulfate, magnesium sulfate, manganese sulfate, etc., and listed as trivalent metal salts, are aluminum chloride, ferric chloride, etc. Any of these are suitably selected in accordance with the application. Generally, the critical coagulation concentration (coagulation value or coagulation point) of divalent metallic salts is less than that of monovalent metallic salts. Furthermore, the critical coagulation concentration of trivalent metallic salts is lowered.

The critical coagulation concentration is an index of the stability of dispersed materials in an aqueous dispersion, and shows the concentration at which coagulation is initiated. This critical coagulation concentration varies greatly depending on the fine polymer particles as well as dispersing agents, for example, as described in Seizo Okamura, et al, Kobunshi Kagaku (Polymer Chemistry), Vol. 17, page 601 (1960), etc., and the value can be obtained with reference to the above-mentioned publications. Further, as another method, the critical coagulation concentration may be obtained as described below. An appropriate salt is added to particle dispersion while changing the salt concentration to measure the ξ potential of the dispersion, and in addition the critical coagulation concentration may be obtained as the salt concentration which initiates a variation in the ξ potential.

The polymer particles dispersion liquid is processed by employing metal salt so as to have density not less than critical coagulation density. In this instance the metal salt is added directly or in a form of aqueous solution optionally, which is determined according to the purpose. In case that it is added in an aqueous solution the metal salt must satisfy the critical coagulation density including the water as the solvent of the metal salt.

The concentration of coagulant may be not less than the critical coagulation concentration. However, the amount of the added coagulant is preferably at least 1.2 times of the critical coagulation concentration, and more preferably 1.5 times.

Suitable temperature for the process of coagulation and fusion is between Tg plus 10 and Tg plus 50° C., preferably Tg plus 15 and Tg plus 40° C.

In the procedure, the polymerization reaction is not inhibited since the preparation of the compound resin particle is performed in the system without colorant. Consequently, the anti-offset property is not deteriorated and contamination of the apparatus and the image caused by the accumulation of the toner is not occurred.

Moreover, the monomer or the oligomer is not remained in the colored resin particle since the polymerization reaction for forming the compound resin particle is completely performed. Consequently, any offensive odor is not occurred in the fixing process by heating in the image forming method using such the toner.

The surface property of thus produced colored resin particle is uniform and the charging amount distribution of the toner is sharp. Accordingly, an image with a high sharpness can be formed for a long period. The anti-offset and anti-winding properties can be improved and an image with suitable glossiness can be formed while a suitable adhesiveness or a high fixing strength with the recording material or recording paper or image support in the image forming method including a fixing process by contact heating by the use of such the toner which is uniform in the composition, molecular weight and the surface property of the each particles.

<Filtration and Washing Process>

In the filtration and washing process, filtration is carried out in which said colored resin particles are collected from the colored resin particle dispersion, and washing is also carried out in which additives such as surface active agents, salting-out agents, and the like, are removed from the collected colored resin particles (a cake-like aggregate). Filtering methods are not particularly limited, and include a centrifugal separation method, a vacuum filtration method which is carried out employing Buchner funnel and the like, a filtration method which is carried out employing a filter press, and the like.

<Drying Process>

The drying process is one in which said washed colored resin particles are dried.

Listed as dryers employed in this process may be spray dryers, vacuum freeze dryers, vacuum dryers, and the like. Further, standing tray dryers, movable tray dryers, fluidized-bed layer dryers, rotary dryers, stirring dryers, and the like are preferably employed.

Vacuum drying is conducted at lower temperature than Tg of the resin of toner particles. Reduced pressure and drying time is determined suitably.

Aggregates may be subjected to crushing treatment when dried colored resin particles are aggregated due to weak attractive forces among particles. Herein, employed as crushing devices may be mechanical a crushing devices such as a jet mill, a Henschel mixer, a coffee mill, a food processor, and the like.

The toner particles of this invention may contain an inner additive such as a charge controlling agent and a releasing agent. The charge controlling agent can be incorporated in the same way as addition of colorant particle in the course of coagulation, and the releasing agent is incorporated by dissolving it in a monomer solution in the course of polymerization.

(Release Agents)

The added amount of the compounds is typically from 1 to 30 percent by weight with respect to the total toner, is preferably from 2 to 20 percent, and is more preferably from 3 to 15 percent.

Preferred as compounds which exhibit a release function are low molecular weight polypropylene (having a number average molecular weight of 1,500 to 9,000) and low molecular weight polyethylene. Particularly preferred compounds are the ester based compounds represented by the formula described below.

R₁-(OCO-R₂)ₙ

Wherein n is commonly an integer of 1 through 4; is preferably 2, 3, or 4; is more preferably 3 or 4; and is most preferably 4; and R₁ and R₂ each represents a hydrocarbon group which may have a substituent. R₁ has commonly from 1 to 40 carbon atoms, preferably from 1 to 20 carbon atoms, and more preferably from 2 to 5 carbon atoms. R₂ has commonly from 1 to 40 carbon atoms, preferably from 16 to 30 carbon atoms, and more preferably from 18 to 26 carbon atoms.

Examples of the representative compounds are shown below.

1) CH₃—(CH₂)₁₂—COO—(CH₂)₁₇—CH₃

2) CH₃—(CH₂)₁₈—COO—(CH₂)₁₇—CH₃

3) CH₃—(CH₂)₂₀—COO—(CH₂)₂₁—CH₃

4) CH₃—(CH₂)₁₄—COO—(CH₂)₁₉—CH₃

5) CH₃—(CH₂)₂₀—COO—(CH₂)₆—O—CO—(CH₂)₂₀—CH₃

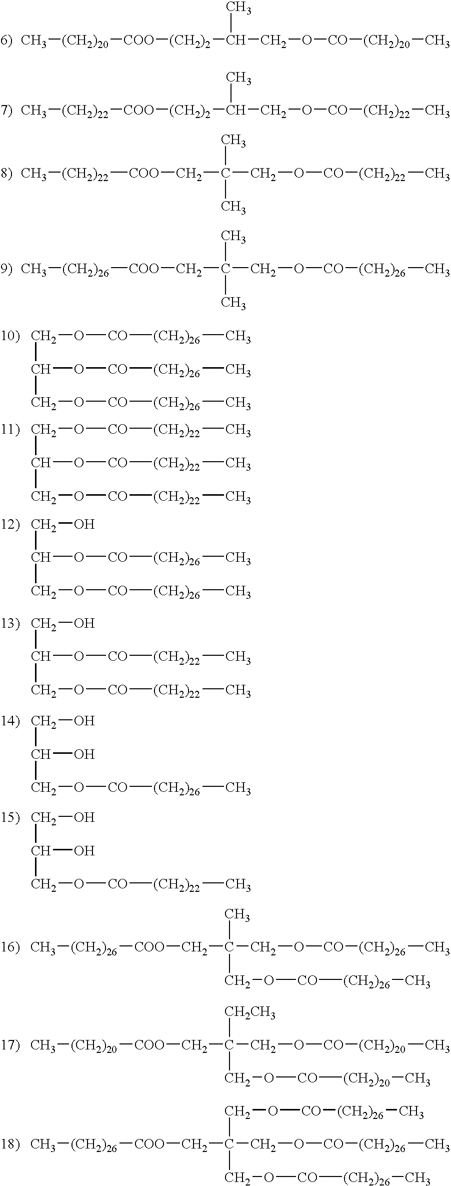

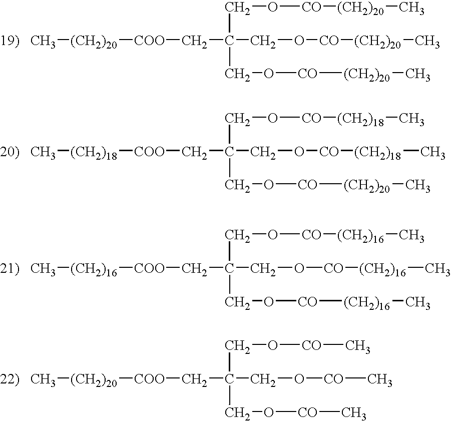

(Charge Controlling Agent)

Various types of charge control agents, which can be dispersed in water, may also be employed. Specifically listed are nigrosine based dyes, metal salts of naphthenic acid or higher fatty acids, alkoxylated amines, quaternary ammonium salts, azo based metal complexes, salicylic acid metal salts or metal complexes thereof.

(External Additives)

For the purpose of improving fluidity as well as chargeability, and of enhancing cleaning properties, the toner of the present invention may be employed into which so-called external additives are incorporated. Said external additives are not particularly limited, and various types of fine inorganic particles, fine organic particles, and lubricants may be employed.

Employed as fine inorganic particles may be those conventionally known in the art. Specifically, it is possible to preferably employ fine silica, titanium, and alumina particles and the like. These fine inorganic particles are preferably hydrophobic. As this inorganic fine particle, the use of particles of inorganic oxide such as silica, titania and alumina is preferable, and further, it is preferable that these inorganic fine particles have been hydrophobic-processed by silane coupling agents or titanium coupling agents. As an extent of hydrophobic processing, it is not limited in particular, but the one with methanol wettability of 40·95 is preferable. The methanol wettability is one to evaluate wettability for methanol. In this method, 0.2 g of inorganic fine particles to be measured is measured and added to 50 ml of distilled water in a beaker with capacity of 200 ml. Methanol is dropped slowly, under the state of slow stirring, from a buret whose tip is dipped in a liquid, until the whole of inorganic fine particles are wetted. When a·(ml) represents an amount of methanol needed to wet the inorganic fine particles completely, a degree of hydrophobicity is calculated by the following formula.

Degree of hydrophobicity=(a/(a+50))×100

For the organic particles example includes styrene resin fine particles, styrene-acryl resin fine particles, polyester resin particles and urethane resin fine particles.

Amount of the external additives is preferably 0.1 to 5.0% by weight, and preferably 0.5 to 4.0% by weight. A plurality of external additives may be employed in combination.

(Developer)

The toner of the present invention may be employed in either a single component developer or a double component developer.

The single component developer includes a non-magnetic single component developer and a magnetic single component developer in which magnetic particles, having a size of about 0.1 to about 0.5 μm, are incorporated in the toner. The toner of the present invention may be employed in either of these.

Further, the toner of the present invention may be employed in the double component developer upon being mixed with a carrier. In such a case, employed as magnetic particles of the carrier may be materials such as metals, for example, iron, ferrite, and magnetite, and alloys of metals such as aluminum and lead with the metals, which are conventionally known in the art. Of these, ferrite particles are particularly preferred. The volume average particle diameter of the magnetic particles is preferably from 15 to 100 μm, and is more preferably from 25 to 80 μm.

It is possible to determine the volume average particle diameter of a carrier, employing a representative apparatus such as a laser diffraction type particle size analyzer “HELOS” (manufactured by Sympatec Co.) fitted with a wet type homogenizer.

Preferred as carriers are those in which magnetic particles are further coated with resins or so-called resin dispersed type carriers in which magnetic particles are dispersed in resins. Resin compositions for coating are not particularly limited. Employed as such resins are, for example, olefin based resins, styrene based resins, styrene-acryl based resins, silicone based resins, ester based resins, and fluorine-containing polymer based resins. Further, resins employed to constitute the resin dispersed type carrier are not particularly limited, and those known in the art may be employed. For example, employed may be styrene-acryl based resins, polyester resins, fluorine based resins, and phenol based resins.

<Image Forming Method>

An example of an image forming apparatus which can be employed for the image forming method using the toner of he invention.

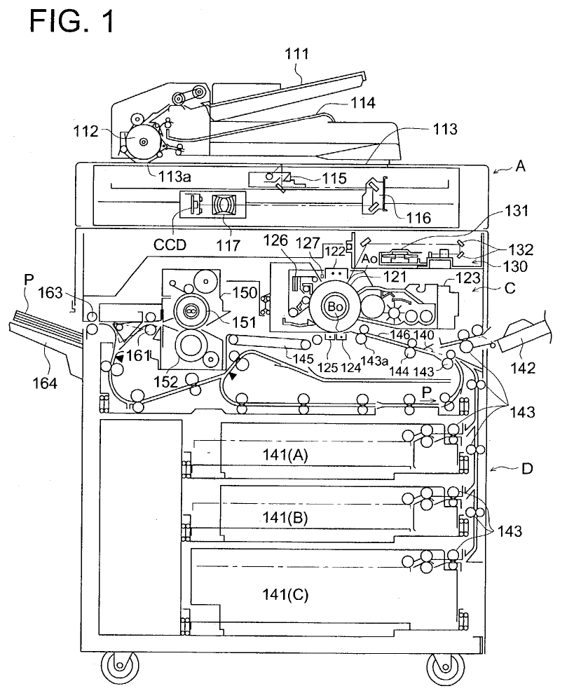

FIG. 1 is a cross-sectional view of an electrophotographic image forming apparatus as one example of the image forming apparatus of the present invention.

The image forming apparatus shown in FIG. 1 is one employing a digital system, and is comprised of image reading section A, image processing section B (not shown), image forming section C, and transfer paper conveying section D as the transfer paper conveying means.

In the upper part of image reading section A, provided is an automatic document conveying means which automatically conveys the original documents. Original documents, which are placed on document platen 111, are conveyed sheet by sheet and conveyed by original document conveying roller 112, and image reading is carried out at reading position 113a. The original document, which has been read, is ejected onto document ejecting tray 114, utilizing document conveying roller 12.

On the other hand, the image of the original document, which is placed on platen glass 113, is read by reading operation at a speed of v of first mirror unit 115 comprised of an illuminating lamp and a first mirror which constitutes an optical scanning system and by movement at a speed of v/2 in the same direction of second mirror unit 116 comprised of a second mirror and a third mirror which are positioned in a V letter.

The read image is focused through projection lens 117 onto the receptor surface of imaging sensor CCD of a line sensor. The linear optical image, which has been focused onto the imaging sensor CCD, is successively subjected to photoelectric conversion to obtain electric signals (brightness signals), and thereafter, is subjected to A/D conversion. The resultant signals are then subjected to various processes such as density conversion, a filtering process, and the like in image processing section B, and then the resultant image data are temporarily stored in a memory.

In image forming section C, arranged as image forming units are drum-shaped image bearing photoreceptor (hereinafter referred to as a photoreceptor drum) 121, and around said photoreceptor drum, charging unit 122 as the charging means, development unit 123 as the development means, transfer unit 124 as the transfer means, separating unit1 25 as the separating means, cleaning unit 126 and PCL (pre-charge lamp) 127 in said order for each cycle. Photoreceptor 121 is prepared by applying photoconductive compounds onto a drum base body. For example, organic photoconductors (OPC) are preferably employed. Said drum rotates clockwise as shown in FIG. 1.

After rotating the photoreceptor is uniformly charged employing charging unit 122, image exposure is carried out based on image signals retrieved from the memory of image processing section B, employing exposure optical system 130. In said exposure optical system 30 which is utilized as the writing means, a laser diode (not shown) is employed as the light emitting source, and primary scanning is carried out in such a manner that light passes through rotating polygonal mirror 131, an fθ lens (having no reference numeral), and a cylindrical lens (also having no reference numeral), and the light path is deflected by reflection mirror 132. As a result, image exposure is carried out at position A₀ with respect to photoreceptor 121, and a latent image is formed by the rotation (secondary scanning) of photoreceptor 121. In one example of the present embodiment, exposure is carried out for a text section and the latent image is formed.

The latent image on photoreceptor 121 is subjected to reversal development employing development unit 123, and a visualized toner image is formed on the surface of said photoreceptor 121. In transfer sheet conveying section D, under the image forming unit provided are sheet supply units 141(A), 141(B), and 141(C) as paper sheet storing means, in which different-sized paper sheets P are stored, and provided on the exterior, is manual paper sheet supply unit 142 by which paper sheets are manually supplied. Paper sheet P, which is selected from any of these paper sheet supply units is conveyed along conveying path 140 employing paired guide rollers 143, and the conveyance of the paper sheet P is temporarily suspended by paired register rollers 144 which correct the inclination as well as the deviation of the paper sheet P, and thereafter the conveyance resumes again. Paper sheet P is guided by conveyance path 140, paired pre-transfer rollers 143a, and guide plate 146 so that the toner image on photoreceptor 121 is transferred onto paper sheet P at transfer position B₀ employing transfer unit 124. Subsequently, charge elimination is carried out employing separation unit 125; paper sheet P is separated from the surface of the photoreceptor 121 and is conveyed to fixing unit 150, employing conveying unit 45.

Fixing unit 150 comprises fixing roller 151 as well as pressure roller 152. By passing paper sheet P between fixing roller 151 and pressure roller 152, heat as well as pressure is applied to melt-fix the toner. Paper sheet P, which has been subjected to fixing of its toner image, is ejected onto paper sheet ejecting tray 164 after cooled by a cooling device 163 so that the temperature of paper sheet P is 80° C. or lower during continuous printing.

### EXAMPLES

The embodiments as well as effects of the present invention will be specifically described with reference to examples.

Preparation of Colored Resin Particle 1

Preparation of Core Particle (First Step Polymerization)

Charged into a 5,000 ml separable flask fitted with a stirring unit, a temperature sensor, a cooling pipe, and a nitrogen inlet unit was a surface active agent solution (a water-based medium) which was prepared by dissolving 4.0 g of an anionic surface active agent A (C₁₀H₂₁(OCH₂CH₂)₂OSO₃Na in 3,010 g of deionized water. Subsequently, while stirring at 230 rpm, temperature in the flask was raised to 80° C. under a flow of nitrogen.

Added to the resulting surface active agent solution was an initiator solution prepared by dissolving 10.0 g of a polymerization initiator (potassium persulfate: KPS) in 300 g of deionized water, and subsequently, the resulting mixture was heated to 75° C. Thereafter, a monomer mix solution, comprised of 70.1 g of styrene, 19.9 g of n-butyl acrylate, and 10.9 g of methacrylic acid, was added dropwise over one hour. While stirring, the resulting system underwent polymerization (first step polymerization) while heated to 75° C. for two hours, whereby polymerization reaction initiates. When propagation ratio reached to 94%, initiator solution in which 3.0 g of KPS was dissolved in 100 g of deionized water, was added, and they were heated to 75° C. and stirred for 2 hours to conduct the first step polymerization. Resin particles (a dispersion of resin particles comprised of a high molecular weight resin) were prepared. The propagation ratio was 98% at this stage. The resulting particles were designated as “Resin Particles 1H”. These are used as core particles.

(2) Formation of the Interlayer (the Second Step Polymerization)

To a mixture of 105.6 g of styrene, 30.0 g of n-butyl acrylate, 15.4 g of methacrylic acid, and 5.6 g of n-pentyl mercaptan in a flask fitted with a stirring unit, 72.0 g of the releasing agent represented by the above mentioned formula 19) was added and they were heated to 80° C. so as to dissolve, whereby Monomer Solution 1 was obtained. Separately, a surface active agent solution prepared by dissolving 1.6 g of the anionic surface active agent A in 2,700 g of deionized water was heated to 98° C. Subsequently, 28 g of the Resin Particles 1H as a solid, which were employed as a dispersion of nucleus particles, was added to the resulting surface active agent solution. The resulting mixture was mixed with the monomer solution 1 and dispersed for 8 hours, employing a mechanical homogenizer having a circulation pass “CLEARMIX” (manufactured by M-Technique Co., Ltd.), whereby a dispersion (an emulsion composition), comprising emulsified particles (oil droplets) having dispersion particle diameter of 284 nm was prepared.

Then to the emulsion, a polymerization initiator solution composed of 5 g of the polymerization initiator KPS dissolved in 150 g of ion-exchanged water and 750 g of ion-exchanged water were added. This system was heated and stirred at 80° C. to initiate polymerization reaction, and a solution of polymerization initiator solution composed of 1.5 g of the polymerization initiator KPS dissolved in 50 g of ion-exchanged water was added at the time that the propagation ratio reached to 94%, and the system was heated to 75° C. and stirred for 2 hours so as to perform polymerization (the second step polymerization). Thus latex or a dispersion of complex resin particles, which is comprised of high molecular weight resin particles each covered with the medium molecular weight resin, was prepared. The propagation ratio was 98%. The latex was referred to as “Resin Particles 1HM”.

(3) Formation of the Outer Layer (the Third Step of Polymerization)

An initiator solution composed of 6.8 g of the polymerization initiator KPS and 200 g of ion-exchanged water was added to the above-obtained Latex 1HM. To thus obtained dispersion, a monomer mixture liquid composed of 300 g of styrene, 95 g of n-butyl acrylate, 15.3 g of methacrylic acid and 10.4 g of n-pentyl mercaptan was dropped taking for 1 hour. After the completion of the dropping, polymerization was initiated by stirring and heating at 80° C., and a polymerization initiator solution composed of 2.0 g of the polymerization initiator KPS dissolved in 65 g of ion-exchanged water was added at the time that the propagation ratio reached to 94%, and the system was heated to 80° C. and stirred for 2 hours so as to perform polymerization (the third step of polymerization). Then the suspension was cooled by 28° C. Thus a latex was obtained, which is a dispersion of resin particles each having the core of the high molecular weight resin, the interlayer of the medium molecular weight resin containing Exemplified Compound (1) of the Formula 1, and the outer layer. The propagation ratio was 98%. The latex was referred to as “Resin Particles 1HML”.

Preparation of Latex 1L

A polymerization initiator solution composed of 14.8 g of the polymerization initiator, potassium persulfate KPS, dissolved 400 g ion-exchanged water was added and heated by 80° C. The a monomer mixture liquid composed of 600 g of styrene, 190 g of n-butyl acrylate, 30 g of acrylic acid and 20.0 g of n-pentyl mercaptan was dropped into the surfactant solution and heated and stirred for 2 hours at 80° C. to perform polymerization. Then it was cooled to 28° C., and latex of resin particles having low molecular weight was obtained. The propagation ratio was 98%. Thus obtained dispersion was referred to as “Latex 1L”.

The resin particle constituting Latex 1L had peaks of molecular weight at 11,000, and the weight average diameter of the complex resin particle was 128 nm.

(Dispersing of Colorant)

In 1,600 g of ion-exchanged water, 90.0 g of the anionic Surface Active Agent A was dissolved by stirring, and then 400.0 g of Pigment Blue 15:3 was gradually added while stirring. Thereafter, the pigment was dispersed by a stirring machine CLEARMIX manufactured by M-Technique Co., Ltd. Thus a dispersion of colorant particles, hereinafter referred to as Colorant Dispersion 1, was prepared. The particle diameter of the colorant particle was 110 nm which was measured by an electrophoresis light scattering photometer ELS 800, manufactured by Otsuka Electronics CO., LTD.

(Coagulation, Fusion-adhesion Process)

Into a reaction vessel or a four mouth flask to which a thermo sensor, cooler, nitrogen gas introducing device and stirring device were attached, 420.7 g of Resin Particles 1HML in terms of solid ingredients, 900 g of ion-exchanged water and Colorant Dispersion 1 were charged and stirred. The temperature of the contents of the flask was adjusted to 30° C. Then 5 moles per liter aqueous solution of sodium hydroxide was added so as to make the pH value of 9.0.

Thereafter, a solution composed of 12.1 g of magnesium chloride hexahydrate and 1,000 g of ion-exchanged water was added to the above-obtained dispersion spending 10 minutes at 30° C. while stirring. After standing for 3 minutes, the system was heated so that the temperature is attained at 90° C. taking 60 minutes. The particle size of the associated particle was measured by Coulter Counter TA-II in such the status and a solution composed of 40.2 g of sodium chloride and 1,000 g of ion-exchanged water was added at the time at which the number average particle diameter were attained at 5.0 μm to stop the growing of the particle. The heating and stirring were further continued 2 hours at 98° C. as a ripening treatment for continuing the fusion-adhering of the particles. It was cooled by 30° C. at 8° C./min.

(Shell Forming Procedure)

After the above-described treatment of the coagulation, fusion-adhering and association, 96 g of Latex 1L was added to the obtained particles and heating and stirring were continued for 3 hours so that the Latex 1L was fusion-adhered onto the associated particle of Resin Particles 1HML. Then 40.2 g of sodium chloride was added and the system was cooled by 30° C. in a rate of 8° C., and the pH was adjusted to 2.0 by the addition of hydrochloric acid, and the stirring was stopped.

Thus produced salted, coagulated and fusion-adhered particles were filtered and washed by using ion-exchanged water at 45° C. repeatedly. Residual volatile substance (including unreacted monomer) was removed by drying by employing vacuum dryer for 10 hours at 10 kPa, and 45° C. The resultant was pulverized by Henschel Mixer and sieved with 45 μm mesh to obtain Colored Resin Particle 1.

Preparation of Colored Resin Particle 2

Colored Resin Particle 2 was obtained in the same way as the Colored Resin Particle 1 except that the chain transfer agent n-pentyl mercaptan was replaced by n-octyl mercaptan.

Preparation of Colored Resin Particle 3

Colored Resin Particle 3 was obtained in the same way as the Colored Resin Particle 1 except that n-pentyl mercaptan was replaced by n-decyl mercaptan.

Preparation of Colored Resin Particle 4

Colored Resin Particle 4 was obtained in the same way as the Colored Resin Particle 1 except that drying temperature was changed to 30° C. from 40° C.

Preparation of Colored Resin Particle 5

Colored Resin Particle 5 was obtained in the same way as the Colored Resin Particle 1 except that drying time was changed to 5 hours from 10 hours.

Preparation of Colored Resin Particle 6

Colored Resin Particle 5 was obtained in the same way as the Colored Resin Particle 1 except that drying temperature was changed to 30° C. from 40° C. and drying time was changed to 5 hours from 10 hours.

Preparation of Colored Resin Particle 7

Colored Resin Particle 7 was obtained in the same way as the Colored Resin Particle 1except that drying time was changed to 20 hours from 10 hours.

Preparation of Colored Resin Particle 8

Colored Resin Particle 8 was prepared in the same way as the Colored Resin Particle 1 except that processes of the Preparation of Core Particle, Formation of the Interlayer, and Formation of the Outer Layer were modified as described below, and the drying time was changed to 20 hours from 10 hours.

Preparation of Core Particle (First Step Polymerization) Charged into a 5,000 ml separable flask fitted with a stirring unit, a temperature sensor, a cooling pipe, and a nitrogen inlet unit was a surface active agent solution (a water-based medium) which was prepared by dissolving 7.08 g of an anionic surface active agent A (C₁₀H₂₁(OCH₂CH₂)₂OSO₃Na in 3,010 g of deionized water. Subsequently, while stirring at 230 rpm, temperature in the flask was raised to 80° C. under a flow of nitrogen.

Added to the resulting surface active agent solution was an initiator solution prepared by dissolving 10.0 g of a polymerization initiator (potassium persulfate: KPS) in 300 g of deionized water, and subsequently, the resulting mixture was heated to 75° C. Thereafter, a monomer mix solution, comprised of 70.1 g of styrene, 19.9 g of n-butyl acrylate, and 10.9 g of methacrylic acid, was added dropwise over one hour. While stirring, the resulting system underwent polymerization (first step polymerization) while heated to 75° C. for two hours, whereby polymerization reaction initiates. When propagation ratio reached to 94%, initiator solution in which 3.0 g of KPS was dissolved in 50 g of deionized water, was added, and they were heated to 75° C. to conduct polymerization, and when propagation ratio reached to 97%, initiator solution in which 3.0 g of KPS was dissolved in 50 g of deionized water, was added, and they were heated to 75° C. and stirred for 2 hours to conduct the first step polymerization. Resin particles (a dispersion of resin particles comprised of a high molecular weight resin) were prepared. The propagation ratio was 99% at this stage. The resulting particles were designated as “Resin Particles 8H”.

(2) Formation of the Interlayer (the Second Step Polymerization)

To a mixture of 105.6 g of styrene, 105.6 g of styrene, 30.0 g of n-butyl acrylate, 15.4 g of methacrylic acid, and 5.6 g of n-pentyl mercaptan in a flask fitted with a stirring unit, 72.0 g of the releasing agent represented by the above mentioned formula 19) was added and they were heated to 80° C. so as to dissolve, whereby Monomer Solution 2 was obtained. Separately, a surface active agent solution prepared by dissolving 1.6 g of the anionic surface active agent A in 2,700 g of deionized water was heated to 98° C. Subsequently, 28 g of the Resin Particles 8H as a solid, which were employed as a dispersion of nucleus particles, was added to the resulting surface active agent solution. The resulting mixture was mixed with the monomer solution 1and dispersed for 8 hours, employing a mechanical homogenizer “CLEARMIX” (manufactured by M-Technique Co., Ltd.), whereby a dispersion (an emulsion composition), comprising emulsified particles (oil droplets) having dispersion particle diameter of 284 nm was prepared.

Then to the emulsion, a polymerization initiator solution composed of 5 g of the polymerization initiator KPS dissolved in 150 g of ion-exchanged water and 750 g of ion-exchanged water were added. This system was heated and stirred at 80° C. to initiate polymerization reaction, and a polymerization initiator solution composed of 1.5 g of the polymerization initiator KPS dissolved in 25 g of ion-exchanged water was added at the time that the propagation ratio reached to 94%, and the system was heated to 80° C. and stirred so as to perform polymerization, and further, a polymerization initiator solution composed of 1.5 g of the polymerization initiator KPS dissolved in 25 g of ion-exchanged water was added at the time that the propagation ratio reached to 97%, and the system was heated to 75° C. and stirred for 2 hours so as to perform polymerization (the second step polymerization). Thus latex or a dispersion of complex resin particles, which is comprised of high molecular weight resin particles each covered with the medium molecular weight resin, was prepared. The propagation ratio was 98%. the latex was referred to as “Resin Particles 8HM”.

(3) Formation of the Outer Layer (the Third Step of Polymerization)

An initiator solution composed of 6.8 g of the polymerization initiator KPS and 200 g of ion-exchanged water was added to the above-obtained Latex 1HM. To thus obtained dispersion, a monomer mixture liquid composed of 300 g of styrene, 95 g of n-butyl acrylate, 15.3 g of methacrylic acid and 10.4 g of n-pentyl mercaptan was dropped taking for 1 hour. After the completion of the dropping, polymerization was initiated by stirring and heating at 80° C., and a polymerization initiator solution composed of 1.5 g of the polymerization initiator KPS dissolved in 32.5 g of ion-exchanged water was added at the time that the propagation ratio reached to 94%, and the system was heated to 80° C. and stirred, and further, a polymerization initiator solution composed of 2.0 g of the polymerization initiator KPS dissolved in 32.5 g of ion-exchanged water was added at the time that the propagation ratio reached to 97%, and the system was heated to 80° C. and stirred for 2 hours so as to perform polymerization (the third step of polymerization). Then the suspension was cooled by 28° C. Thus a latex was obtained, which is a dispersion of resin particles each having the core of the high molecular weight resin, the interlayer of the medium molecular weight resin containing Exemplified Compound (1) of the Formula 1, and the outer layer. The propagation ratio was 99%. The latex was referred to as “Resin Particles 8HML”.

Preparation of Latex 8L

A polymerization initiator solution composed of 14.8 g of the polymerization initiator, potassium persulfate KPS, dissolved 400 g ion-exchanged water was added and heated by 80° C. The a monomer mixture liquid composed of 600 g of styrene, 190 g of n-butyl acrylate, 30 g of acrylic acid and 20.0 g of n-pentyl mercaptan was dropped into the surfactant solution and heated and stirred for 1 hours at 80° C. to perform polymerization, and a polymerization initiator solution composed of 4.4 g of the polymerization initiator KPS dissolved in 200 g of ion-exchanged water was added at the time that the propagation ratio reached to 94%, and the system was heated to 80° C. and stirred, and further, a polymerization initiator solution composed of 3.0 g of the polymerization initiator KPS dissolved in 100 g of ion-exchanged water was added at the time that the propagation ratio reached to 97%, and the system was heated to 80° C. and stirred for 2 hours so as to perform polymerization. Then it was cooled to 28° C., and latex of resin particles having low molecular weight was obtained. The propagation ratio was 98%. Thus obtained dispersion was referred to as “Latex 8L”.

Preparation of Colored Resin Particle 9

Colored Resin Particle 9 was prepared in the same way as the Colored Resin Particle 1except that processes of the Preparation of Core Particle, Formation of the Interlayer, and Formation of the Outer Layer were modified as described below.

Preparation of Core Particle (First Step Polymerization)

Charged into a 5,000 ml separable flask fitted with a stirring unit, a temperature sensor, a cooling pipe, and a nitrogen inlet unit was a surface active agent solution (a water-based medium) which was prepared by dissolving 7.08 g of an anionic surface active agent A (C₁₀H₂₁(OCH₂CH₂)₂OSO₃Na in 3,010 g of deionized water. Subsequently, while stirring at 230 rpm, temperature in the flask was raised to 80° C. under a flow of nitrogen.

Added to the resulting surface active agent solution was an initiator solution prepared by dissolving 9.2 g of a polymerization initiator (potassium persulfate: KPS) in 200 g of deionized water, and subsequently, the resulting mixture was heated to 75° C. Thereafter, a monomer mix solution, comprised of 70.1 g of styrene, 19.9 g of n-butyl acrylate, and 10.9 g of methacrylic acid, was added dropwise over one hour. While stirring, the resulting system underwent polymerization (first step polymerization) while heated to 75° C. for two hours, whereby dispersion of resin particles having high molecular weight was obtained. The resulting particles were designated as “Resin Particles 9H”.

(2) Formation of the Interlayer (the Second Step Polymerization)

To a mixture of 105.6 g of styrene, 30.0 g of n-butyl acrylate, 15.4 g of methacrylic acid, and 5.6 g of n-pentyl mercaptan in a flask fitted with a stirring unit, 72.0 g of the releasing agent represented by the above mentioned formula 19) was added and they were heated to 80° C. so as to dissolve, whereby Monomer Solution 3 was obtained. Separately, a surface active agent solution prepared by dissolving 1.6 g of the anionic surface active agent A in 2,700 g of deionized water was heated to 98° C. Subsequently, 28 g of the Resin Particles 9H as a solid, which were employed as a dispersion of nucleus particles, was added to the resulting surface active agent solution. The resulting mixture was mixed with the monomer solution 3 employing a mechanical homogenizer having a circulation pass “CLEARMIX” (manufactured by M-Technique Co., Ltd.), whereby a dispersion (an emulsion composition), comprising emulsified particles (oil droplets) having dispersion particle diameter of 284 nm was prepared.

Then to the emulsion, a polymerization initiator solution composed of 5.1 g of the polymerization initiator KPS dissolved in 240 g of ion-exchanged water and 750 g of ion-exchanged water were added. This system was heated and stirred at 80° C. for 3 hours so as to perform polymerization (the second step polymerization). Thus latex or a dispersion of complex resin particles, which is comprised of high molecular weight resin particles each covered with the medium molecular weight resin, was prepared. The latex was referred to as “Resin Particles 9HM”.

(3) Formation of the Outer Layer (the Third Step of Polymerization)

An initiator solution composed of 7.4 g of the polymerization initiator KPS and 200 g of ion-exchanged water was added to the above-obtained Latex 9HM. To thus obtained dispersion, a monomer mixture liquid composed of 300 g of styrene, 95 g of n-butyl acrylate, 15.3 g of methacrylic acid and 10.4 g of n-pentyl mercaptan was dropped taking for 1 hour at a temperature of 80° C. After the completion of the dropping, polymerization (the third step of polymerization) was performed for 2 hours while heating and stirring. Then the suspension was cooled by 28° C. Thus a latex was obtained, which is a dispersion of resin particles each having the core of the high molecular weight resin, the interlayer of the medium molecular weight resin containing Exemplified Compound (1) of the Formula 1, and the outer layer of the low molecular weight resin. The latex was referred to as Resin Particles 9HML.

Preparation of Latex 9L

A polymerization initiator solution composed of 14.8 g of the polymerization initiator, potassium persulfate KPS, dissolved 400 g ion-exchanged water was added and heated by 80° C. The a monomer mixture liquid composed of 600 g of styrene, 190 g of n-butyl acrylate, 30 g of acrylic acid and 25 g of n-pentyl mercaptan was dropped into the surfactant solution taking 1 hour, and heated and stirred for 2 hours at 80° C. to perform polymerization. Thus obtained dispersion was referred to as Latex 9L.

Preparation of Colored Resin Particle 10

Colored Resin Particle 10 was obtained in the same way as the Colored Resin Particle 1 except that the chain transfer agent n-pentyl mercaptan was replaced by n-dodecyl mercaptan.

Preparation of Colored Resin Particle 11

Colored Resin Particle 11 was obtained in the same way as the Colored Resin Particle 1 except that drying was conducted at normal pressure.

(Preparation of Toners and Developers)

Each of the above-prepared Colored Resin Particles 1 through 11 and the Comparative Colored Resin Particle 1 was mixed with 1.0% by weight of hydrophobic silica having a number average primary particle diameter of 12 nm and a hydrophobilized degree of 68 and hydrophobic titanium oxide having a number average primary particle diameter of 20 nm and a hydrophobilized degree of 63 by a Henschel mixer to prepare Toners for developing static latent image 1 through 11.

Each of the Toners 1 through 11 was mixed with silicone coated ferrite carrier having a volume average diameter of 60 μm so that the toner concentration was to be made to 6% to prepare Developers 1 through 11.

The toners thus obtained are specified in Table 1.

TABLE 1

| | | | | | | | Head Space | | |
|---|---|---|---|---|---|---|---|---|---|
| | | | | | | Average | Measurement | | |
| | Times of | | | | | Particle | Whole | | |
| | addition | Chain | Drying Process | | | Diameter | volatile | | |
| Toner | of | Transfer | | Temp. | Time | of toner | substance | Monomer | |
| No. | initiator | Agent | Pressure | (° C.) | (hs.) | (μm) | (ppm) | (ppm) | Remarks |
| 1 | 2 times | n-pentyl | Reduced | 45 | 10 | 5.0 | 260 | 19 | Inv. |
| | | mercaptan | | | | | | | |
| 2 | 2 times | n-octyl | Reduced | 45 | 10 | 4.8 | 200 | 14 | Inv. |
| | | mercaptan | | | | | | | |
| 3 | 2 times | n-decyl | Reduced | 45 | 10 | 4.8 | 105 | 11 | Inv. |
| | | mercaptan | | | | | | | |
| 4 | 2 times | n-pentyl | Reduced | 30 | 10 | 5.0 | 295 | 25 | Inv. |
| | | mercaptan | | | | | | | |
| 5 | 2 times | n-pentyl | Reduced | 45 | 5 | 5.1 | 305 | 35 | Inv. |
| | | mercaptan | | | | | | | |
| 6 | 2 times | n-pentyl | Reduced | 30 | 5 | 5.0 | 345 | 48 | Inv. |
| | | mercaptan | | | | | | | |
| 7 | 2 times | n-pentyl | Reduced | 45 | 20 | 4.8 | 95 | 2 | Inv. |
| | | mercaptan | | | | | | | |
| 8 | 3 times | n-pentyl | Reduced | 45 | 20 | 4.8 | 25 | 1 | Inv. |
| | | mercaptan | | | | | | | |
| 9 | 1 time | n-pentyl | Reduced | 45 | 10 | 5.1 | 355 | 55 | Comp. |
| | | mercaptan | | | | | | | |
| 10 | 2 times | n-dodecyl | Reduced | 45 | 10 | 5.0 | 530 | 60 | Comp. |
| | | mercaptan | | | | | | | |
| 11 | 2 times | n-pentyl | Normal | 45 | 10 | 5.0 | 600 | 100 | Comp. |
| | | mercaptan | | | | | | | |

Storage Stability of Toner

Into an sample tube, 2 g of each of the above-prepared toners was sampled and shaken for 50 times by a tapping denser, and then stood for 2 hours under a condition of a temperature of 55° C. and a relative humidity of 35%. Thereafter, the sample was sieved through a sieve with 48 μm mesh by a designated vibration condition. The weight ratio of the toner remained on the sieve to the whole toner was measured, which was referred to as the cohesion ratio. The results were evaluated according to the following norms.

A: The cohesion ratio of the toner was less than 15% by weight; the storage stability of the toner is excellent and no problem was occurred on the image formation.

B: The cohesion ratio of the toner was from 15 to 45% by weight; the storage stability of the toner is good and no problem was occurred on the image formation.

C: The cohesion ratio of the toner was from 46 to 60% by weight; the storage stability of the toner is inferior a little and problems in some degree were raised on the occasion of the image formation but the toner was acceptable for practical use.

D: The cohesion ratio of the toner exceeded to 60% by weight; the storage stability of the toner is bad and the toner was unacceptable for practical use since problems were raised on the occasion of the image formation. Adhesion of output image receiving sheet

A digital copying machine 7065, manufactured by Konica Corp., was used for the test, which is modified by attaching a cooling device after the heat fixing process so that the surface temperature of the output image receiving sheet was 75° C.

The image of an original chart having an image ratio of 7% and quartered by a character image, a portrait image, a solid white image and a solid black image was continuously printed on both sides of 500 image receiving sheets with a weight of 64 g/m² and a size of A4 under a condition of a temperature of 33° C. and a relative humidity of 80%.

The adhesion of the output sheet was evaluated by the easiness of true up the edge of the 500 image receiving sheets output on the output tray.

A: The edges of image receiving sheets were uniformly trued up when the bottom edges of the sheets were hit for 10 times to the table while holding the both sides of the sheets by hands.

B: The edges of image receiving sheets were uniformly trued up when the bottom edges of the sheets were hit for 10 times to the table and further hit for 5 times to upper edge of the sheets while holding the both sides of the sheets by hands.

C: The edges of image receiving sheets were uniformly trued up when the bottom edges of the sheets were hit for 10 times to the table and further hit for 10 times to upper edge of the sheets while holding the both sides of the sheets by hands.

D: The edges of image receiving sheets could not be uniformly trued up even when the bottom edges of the sheets were hit for 10 times to the table and further hit for 10 times to upper edge of the sheets while holding the both sides of the sheets by hands since the sheets were adhered with together by the toner.

Evaluation of Odor

The test was performed in a closed room having a floor area of 5 m×5 m and a height of 2 m using the digital copy machine 7065, manufactured by Konica Corp., which is modified by setting the fixing temperature at 175° C. and attaching a cooling device after the heat fixing process so that the surface temperature of the output image receiving sheet was 75° C. A solid black image with an image ratio of 50% was continuously printed to 1,000 image receiving sheets.

The odor was checked by 30 judging persons, and the evaluation was judged according to the number of the person who perceived the order on the occasion of the finishing of the printing of 1,000 sheets.

A: No judging person perceived the odor.

B: Three or less judging parsons perceived the odor.

C: Four or more judging parsons perceived the odor.

The results are shown in Table 2.

TABLE 2

| Toner | Storage | Adhesion of | | |
|---|---|---|---|---|
| No. | stability | transferred sheet | Odor | Remarks |
| 1 | A | A | A | Invention |
| 2 | A | A | A | Invention |
| 3 | A | A | A | Invention |
| 4 | A | A | A | Invention |
| 5 | A | A | A | Invention |
| 6 | A | C | A | Invention |
| 7 | A | A | A | Invention |
| 8 | A | C | A | Invention |
| 9 | C | D | D | Comparative |
| 10 | D | D | D | Comparative |
| 11 | D | D | D | Comparative |

As is cleared in Table 2, the toner according to the invention is superior to the comparative toner in the storage ability and the output image receiving sheet printed by the inventive toner is easily trued up since the adhesion between the receiving sheets is not occurred and no odor is perceived at the time of fixing.

1. A toner for developing electrostatic latent image comprising a toner particle comprising a binder resin and a colorant, wherein a total amount of a volatile substance contained in the toner is not more than 350 ppm by weight based on the total weight of the toner and an amount of a polymerizable monomer is not more than 50 ppm by weight based on the total weight of the toner, and the amount of the volatile substance and the polymerizable monomer are measured by a head space method.

2. A production method of the toner of claim 1, which comprises;
separating toner particles comprising colorant and a binder resin which are dispersed in water based medium, and
drying the toner particles.

3. A production method of the toner of claim 1, which comprises;
forming a dispersion of toner particles from dispersion particles by coagulating and fusing.

4. A production method of the toner of claim 1, which comprises;
a polymerization process for preparing a resin particle from the monomer;
a coagulation/fusion-adhering process for obtaining toner particle dispersion from the resin particles and the colorant particles;
a filtering and washing process for taking out the toner particles from the toner particle dispersion by filtering and for removing an impurity from the toner particles by washing; and
a drying process for drying the washed toner particles.

5. A production method of claim 4, wherein an alkylmercaptan chain-transfer agent having from 5 to 10 carbon atoms is employed in the polymerization process.

6. A production method of claim 4, wherein polymerization initiator is separately added into plural times in the polymerization process.

7. A production method of claim 4, wherein drying is carried out under reduced pressure.

8. A production method of claim 4, wherein
alkylmercaptan having from 5 to 10 carbon atoms is used as the chain-transfer agent, and the polymerization initiator is separately added into plural times in the polymerization process, and
drying is carried out under the reduced pressure in the drying process.

9. An image forming method comprising;
forming a static latent image;
forming a toner image by developing the static latent image using a developer containing the toner for developing the static latent image to form a toner image;
transferring the toner image to a image receiving material;
fixing by heat the toner image on the image receiving material; and a process for cooling the toner image fixed by heating, wherein the toner image is formed by employing a toner of claim 1.
